(19) United States
(12) Patent Application Publication
(10) Pub. No.: US 2010/0006229 A1
(43) Pub. Date: Jan. 14, 2010

(54) DEVICE FOR PRODUCING LAMINATED FILM

(75) Inventors: MING LANG HUNG, Taipei City (TW); CHIH CHEN CHANG, Hsinchu County (TW); PEN CHANG TSENG, Hsinchu County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Industrial Technology Research Institute, Hsinchu (TW)

(21) Appl. No.: 12/422,524

(22) Filed: Apr. 13, 2009

(30) Foreign Application Priority Data
Jul. 11, 2008 (TW) 097126514

(51) Int. Cl. B32B 37/00

(52) U.S. Cl. 156/378; 156/436

(57) ABSTRACT

A device for producing a laminated film includes a plurality of thin film extruding dies, a case, and a thin film pressing module. Each thin film extruding die has a conveying channel, and extrudes a thin film through the conveying channel. The case forms an accommodation space together with the thin film extruding dies. One end of the conveying channels is respectively communicated with the accommodation space. The case has a through hole communicated with the accommodation space. The through hole is connected to a vacuum pump, and the vacuum pump is used to remove the gas in the accommodation space. The thin film pressing module is connected to the case and is located in the accommodation space. The thin film pressing module receives the output thin films, and then stacks, adheres, and presses the thin films together, so as to form a laminated film.

### CROSS-REFERENCE TO RELATED APPLICATIONS

This non-provisional application claims priority under 35 U.S.C. §119(a) on Patent Application No(s). 097126514 filed in Taiwan, R.O.C. on Jul. 11, 2008 the entire contents of which are hereby incorporated by reference.

### BACKGROUND OF THE INVENTION

1. Field of the Invention

The present invention relates to a device for producing a laminated film, which is capable of extruding unit thin films and adhering and pressing the thin films together.

2. Related Art

The conventional processes for manufacturing laminated films are substantially divided into two kinds, namely, a wet process and a dry process.

In the wet manufacturing process, a liquid glue is coated on a surface of a thin film to be laminated, and then a plurality of layers of thin films is stacked and is pressed to be laminated to one another in a hot pressing or cold pressing manner, so as to form a laminated film. However, during the wet manufacturing process of the laminated film, the coating roller continuously rolls back and forth, so the liquid glue usually generates bubbles. When the liquid glue is coated between two adjacent thin films of the laminated film, such bubbles exist between the two adjacent thin films. In this manner, the residual bubbles between the thin films easily result in an oxidation of the thin film materials contacting with the bubbles, so as to affect the service life of the laminated film.

In the dry manufacturing process, each thin film is directly extruded for being laminated and shaped in a co-extruding manner. However, in the conventional manufacturing process, the thin films are generally pressed in a normal atmosphere environment. Thus, when each layer of the thin film is extruded for being laminated, the gas in the air enters the space between the two adjacent thin films, so as to form bubbles. Similarly, the bubbles also result in the oxidation of the thin film materials contacting with the bubbles, so as to affect the service life of the laminated film.

### SUMMARY OF THE INVENTION

In view of the above problems, the present invention is a device for producing a laminated film, thereby solving a problem in the conventional art that bubbles are produced between thin films of the laminated film.

The device for producing the laminated film of the present invention is adapted to connect to a vacuum pump. The device for producing the laminated film comprises a first thin film extruding die, a second thin film extruding die, a case, and a thin film pressing module. The first thin film extruding die has a first conveying channel, and outputs a first thin film through the first conveying channel. The second thin film extruding die has a second conveying channel, and outputs a second thin film through the second conveying channel. The case forms an accommodation space together with the first thin film extruding die and the second thin film extruding die. One end of the first conveying channel and one end of the second conveying channel are respectively communicated with the accommodation space. The case has a through hole communicating with the accommodation space, and the case is connected to the vacuum pump through the through hole. The thin film pressing module is connected to the case and is located in the accommodation space. The thin film pressing module receives the output first thin film and the output second thin film, and presses the first thin film on the second thin film, so as to form a laminated film.

One end of the first conveying channel in the device for producing the laminated film of the present invention is a flat opening.

The device for producing the laminated film of the present invention further comprises an air-tight device, and the case further comprises a laminated film outlet. The air-tight device seals the thin film outlet, and the laminated film passes through the air-tight device and is output out of the device for producing a laminated film. In addition, the air-tight device comprises, for example, a pair of elastic sheets locked on two opposite sides of the laminated film outlet respectively, and the laminated film passes through the air-tight device from the position between the pair of elastic sheets.

The first thin film output module of the device for producing the laminated film of the present invention comprises a main body and a flow regulating module, and the first conveying channel is located in the main body. The first flow regulating module is connected to the main body and is arranged on an extending path of the first conveying channel, so as to adjust a cross-sectional area of a part of segments of the second conveying channel. The flow regulating module comprises, for example, a stopper and a driving module. The stopper is arranged on the extending path of the first conveying channel, and is driven by the driving module to move relative to the first conveying channel, in which a moving direction of the stopper forms an angle with respect to the extending direction of the first conveying channel, and the angle is at a degree of a natural number. The driving module comprises, for example, a fixed base, a worm gear set, and a worm. The fixed base is fixed on the main body, the worm gear set is pivoted on the fixed base in an eccentric manner and leans against the stopper, and the worm is inserted into the main body from an exterior of the main body and is connected to the worm gear set.

In addition to the main body and the flow regulating module, the first thin film output module of the device for producing the laminated film of the present invention further comprises a heating module inserted into the main body, and disposed adjacent to the first conveying channel.

A laminated film producing module of the device for producing the laminated film of the present invention is adapted to receive a third thin film. A gap exists between the first thin film extruding die and the second thin film extruding die, and a height of the gap is greater than a thickness of the third thin film, so that the third thin film enters the accommodation space through the gap.

The laminated film producing module of the device for producing the laminated film of the present invention further comprises, for example, a heat insulating layer arranged between the first thin film extruding die and the second thin film extruding die.

The case of the laminated film producing module of the device for producing the laminated film of the present invention comprises, for example, an opening and a cover plate pivoted on one side of the opening.

The laminated film producing module of the device for producing the laminated film of the present invention further comprises, for example, a temperature sensor, embedded in the first thin film extruding die, and disposed adjacent to the first conveying channel.

Based on the above descriptions, in the present invention, the through hole is connected to the vacuum pump, and the vacuum pump is used to remove the gas in the accommodation space through the through hole, such that a pressure within the accommodation space is lower than an ambient pressure, thereby generating a low pressure environment. The thin film pressing module stacks and presses the thin films together in the low pressure environment, so as to form a laminated film. Therefore, as compared with the conventional art, the present invention can lower the bubble content between two adjacent thin films.

### BRIEF DESCRIPTION OF THE DRAWINGS

The present invention will become more fully understood from the detailed description given herein below for illustration only, and thus is not limitative of the present invention, and wherein:

FIG. 1 is a schematic view of a device for producing a laminated film according to an embodiment of the present invention;

FIG. 2 is a schematic cross-sectional view of FIG. 1;

FIG. 3 is a schematic partially enlarged view of FIG. 2;

FIG. 4A is a schematic top view of a flow regulating module according to the present invention;

FIG. 4B is a schematic side view of the flow regulating module according to the present invention;

FIG. 4C is another schematic side view of the flow regulating module according to the present invention; and

FIG. 5 is another schematic partially enlarged view of FIG. 2.

### DETAILED DESCRIPTION OF THE INVENTION

The present invention provides a device for producing a laminated film, which is adapted to be combined with a vacuum pump, such that a plurality of layers of thin films are laminated to one another under an environment with a pressure lower than the ambient pressure. The device for producing a laminated film of the present invention comprises a plurality of thin film extruding dies, a case, and a thin film pressing module. Each thin film extruding die has a conveying channel and outputs a thin film through the conveying channel. The case forms an accommodation space together with the thin film extruding dies. One end of the conveying channels is respectively communicated with the accommodation space. The extruding dies respectively output thin films made of different materials according to the product types. For example, any output module can be used to output a polymer thin film, a heat melting polymer film, or a metal thin film, in which the polymer thin film is made of, for example, a polyethylene terephthalate (PET) thin film, a nylon thin film, or a low density polyethylene (LDPE) thin film. The case has a through hole communicated with the accommodation space. A vacuum pump is connected to the through hole, and the vacuum pump is used to remove the gas in the accommodation space through the through hole, such that the pressure within the accommodation space is lower than the ambient pressure, thereby generating a low pressure environment. The thin film pressing module is connected to the case and is located in the accommodation space. The thin film pressing module receives the extruded thin films, and stacks and presses the thin films together in the low pressure environment, so as to form a laminated film.

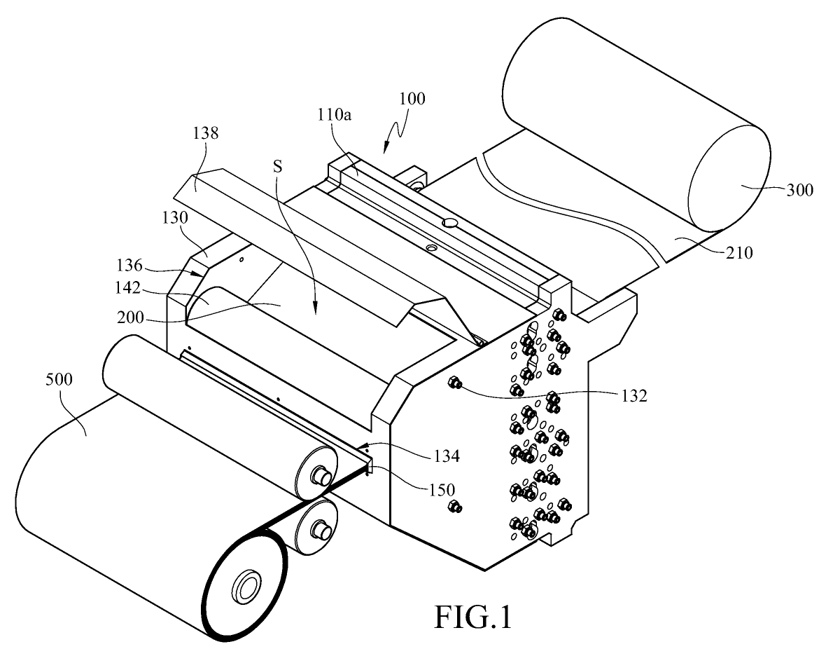

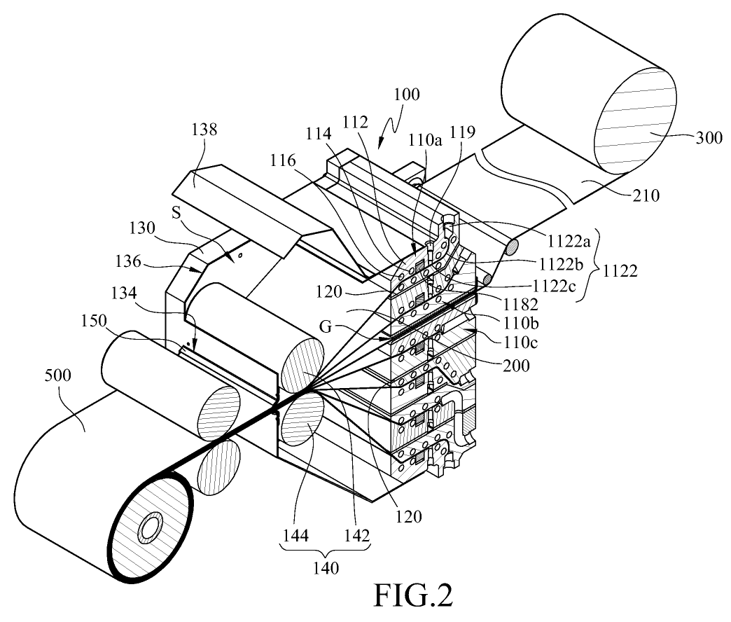

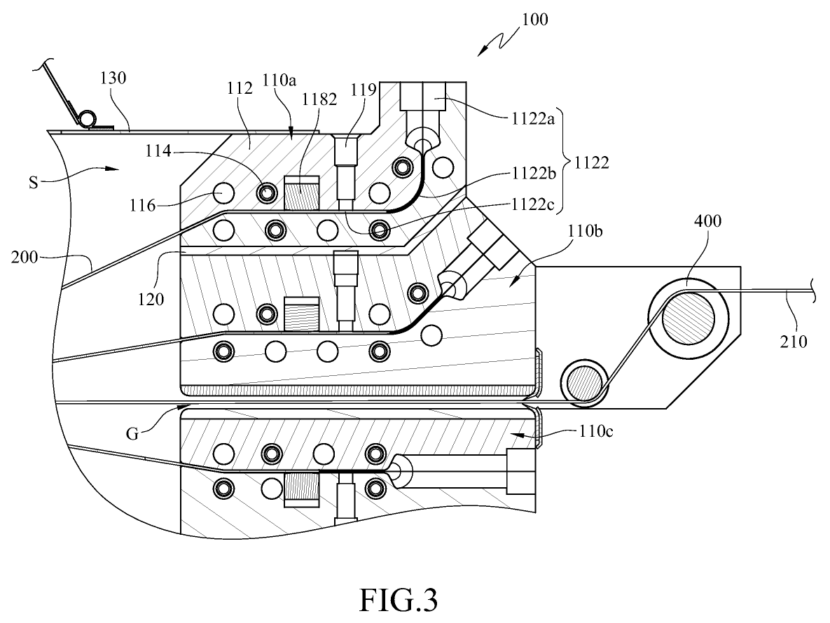

Based on the above descriptions, the present invention becomes apparent to those skilled in the art from the following embodiments. FIG. 1 is a schematic view of a device for producing a laminated film according to an embodiment of the present invention, FIG. 2 is a schematic cross-sectional view of FIG. 1, and FIG. 3 is a schematic partially enlarged view of FIG. 2. Referring to FIGS. 1, 2, and 3, in this embodiment, a device for producing a laminated film 100 comprises a plurality of thin film extruding dies 110. For the ease of making descriptions, a single thin film extruding die 110a is described here in detail. The thin film extruding die 110a comprises a main body 112 and a heating module 114. The main body has a thin film raw material conveying channel 1122. The conveying channel comprises a main channel 1122a, a sub channel 1122b, and a flat plate channel 1122c, in which the sub channel 1122b is connected between the main channel 1122a and the flat plate channel 1122c, and an outlet end of the flat plate channel 1122c is a flat opening. Referring to FIGS. 2 and 3, the heating module 114 is inserted into the main body 112, for improving a temperature of the main body 112, in which the heating module 114 is, for example, a plurality of electric heating rods. After the thin film raw material of the thin film 200 is squeezed into the main body 112 from the main channel 1122a, the thin film raw material is heated to be melted. The melted thin film raw material flows to the flat plate channel 1122c through the sub channel 1122b, and then is gradually diffused, thinned, and cooled. When the cooled thin film raw material is squeezed out from the flat plate channel 1122c, the thin film raw material has been made into a thin film 200.

Furthermore, in order to accurately control the temperature distribution of the main body 112, the main body of this embodiment further has a plurality of cooling liquid channels 116. In this embodiment, the cooling liquid channels 116 are connected to a cooling module (not shown), and the cooling liquid flows in the cooling liquid channels 116, so as to lower the temperature of a local region of the main body, and more accurately control the temperature distribution of the main body 112.

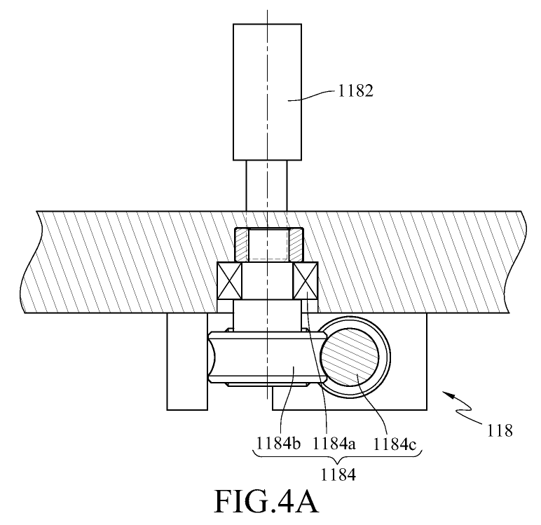

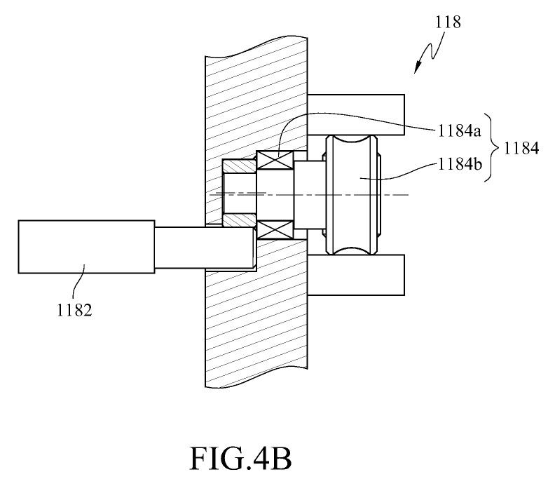

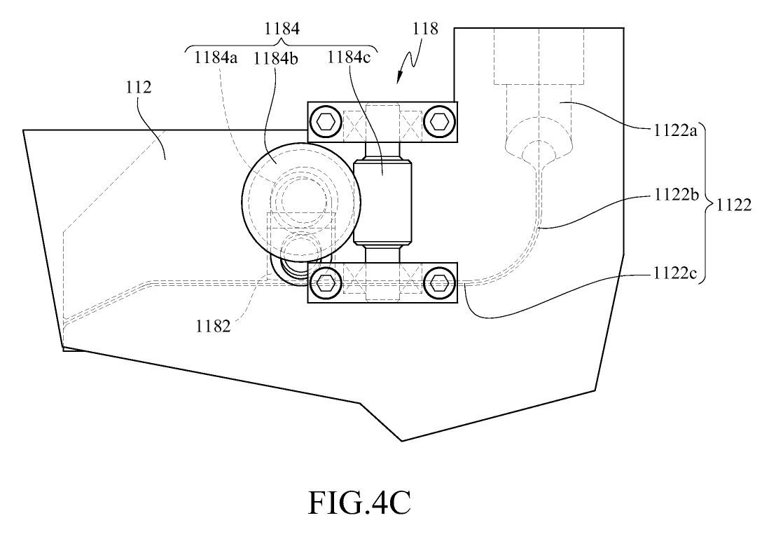

In this embodiment, in order to produce the thin film 200 with a uniform thickness, the thin film extruding die 110a further comprises a flow regulating module. FIGS. 4A to 4C are schematic views of a flow regulating module according to the present invention, in which FIG. 4A is a schematic top view of the flow regulating module, FIG. 4B is a schematic side view of the flow regulating module, and FIG. 4C is another schematic side view of the flow regulating module. Referring to FIG. 2 and FIGS. 4A to 4C, the flow regulating module 118 is connected to the main body 112 and is arranged on an extending path of the conveying channel 1122, so as to adjust a cross-sectional area of a part of segments of the conveying channel 1122. FIGS. 4A to 4C are schematic views of the flow regulating module according to the present invention. Referring to FIGS. 2 and 3 and FIGS. 4A to 4C, the flow regulating module 118 comprises a stopper 1182 and a driving module 1184. The stopper 1182 is arranged on the extending path of the conveying channel 1122, and is connected to the driving module 1184. Preferably, the stopper 1182 is an elongated stopper, and is arranged on the extending path of the flat plate channel 1122c of the conveying channel 1122. After being driven by the driving module 1184, the stopper 1182 moves relative to the conveying channel 1122, and a moving direction of the stopper 1182 forms an angle with respect to the extending direction of the flat plate channel 1122c, in which the angle is at a degree of a natural number. In this embodiment, the moving direction of the stopper 1182 is perpendicular to the extending direction of the flat plate channel 1122c. In this manner, through the relative movement between the stopper 1182 and the flat plate channel 1122c, the cross-sectional area of the flat plate channel 1122c may be adjusted by using the stopper 1182 in this embodiment.

When the thin film raw material squeezed in the main body is a raw material of the polymer thin film, by means of appropriately adjusting a position of the heating module 114 or an output power of the heating module 114, the melted thin film raw material is gradually cooled in this embodiment. Thus, when the melted thin film raw material is squeezed in the flat plate channel 1122c to exceed the stopper 1182, the temperature of the thin film raw material is reduced below a glass transition temperature, so as to form the thin film 200. In this manner, the cross-sectional area of the flat plate channel 1122c is adjusted by adjusting the stopper 1182, so that the thickness of the output thin film 200 can be adjusted in this embodiment. More preferably, the device for producing the laminated film 100 of this embodiment further comprises a temperature sensor 119, which is embedded in the main body 112 of the thin film extruding die 110a and is disposed adjacent to the conveying channel 1122. In this manner, the temperature distribution situation of the main body 112 may be determined by the temperature sensor 119 in this embodiment.

Referring to FIGS. 2 and 3 and FIGS. 4A to 4C, in this embodiment, the driving module 1184 comprises a fixed base 1184a, a worm gear set 1184b, and a worm 1184c. The fixed base 1184a is fixed on the main body 112. The worm gear set 1184b is pivoted on the fixed base 1184a in an eccentric manner and leans against the stopper 1182. The worm 1184c is inserted into the main body 112 from an exterior of the main body 112, and is connected to the worm gear set 1184b. It should be noted that, in this embodiment, the worm 1184c is inserted into the main body from a side wall of the main body 112, in which the thin film extruding die 110a is not connected to the adjacent thin film extruding die 110b through the side wall. Thus, in this embodiment, the thin film extruding die 110b is prevented from generating a heat exchange with the thin film extruding die 110a through the worm 1184c to affect the mutual temperature distribution thereof. When a user rotates the worm 1184c, the worm 1184c drives the worm gear set 1184b to rotate. Meanwhile, the worm gear set 1184b is pivoted on the fixed base 1184a in the eccentric manner and leans against the stopper 1182, such that the stopper 1182 is squeezed by the worm gear set 1184b to move relative to the flat plate channel 1122c. Therefore, through using the stopper 1182 and the driving module 1184 of this embodiment, the cross-sectional area of the flat plate channel 1122c may be adjusted, so as to adjust the thickness of the output thin film 200. Although merely a single driving module 1184 is described in this embodiment, the driving module may be increased to more than one driving modules 1184 by those skilled in the art according to the spirit of this embodiment, in which at least two worm gear sets 1184b are arranged on two opposite sides of the stopper 1182, thereby improving the uniform feature of the thickness of the output thin film 200.

The device for producing the laminated film of this embodiment further comprises a thin film extruding dies 110b and 110c stacked on the thin film extruding die 110a. A melting temperature and a curing temperature of the thin film raw material squeezed in each thin film extruding die are different, such that the temperature distribution of each thin film extruding die is also different. Therefore, in order to prevent the temperature of one thin film extruding die from affecting the temperature of the adjacent thin film extruding die, the device for producing the laminated film 100 of this embodiment further comprises a plurality of heat insulating layers 120, respectively arranged between the two adjacent thin film extruding dies 110.

In this embodiment, the temperature of the thin film raw material is controlled when the thin film raw material flows in the conveying channel, so as to form the thin film 200, and alternatively, the thin film may be further formed beforehand in the present invention. Referring to FIGS. 2 and 3, in this embodiment, since a metal thin film 210 has a high melting point, the metal thin film 210 to be pressed is released by a roll releasing device 300 in this embodiment, in which the material of the metal thin film 210 may be aluminum alloy or other metals. In this embodiment, a flat gap G exists between the two adjacent thin film extruding dies 110b and 110c, in which a height of the gap G is larger than a thickness of the metal thin film 210. In this manner, a thin film output device may output the metal thin film 210 in sequence through a feed roller assembly 400 and the gap G.

Referring to FIGS. 1, 2, and 3, the case 130 is connected to the thin film extruding dies 110, so as to form an accommodation space S together. Preferably, an air-tight process is performed on joining positions between the case 130 and the thin film extruding dies 110 and the joining position between two adjacent thin film extruding dies 110. One end of the conveying channel 1122 in the main body 112 of each thin film extruding die 110 is communicated with the accommodation space S. The wall surface of the case 130 has a plurality of through holes 132, and the case 130 is connected to a vacuum pump (not shown) through the through holes 132. The vacuum pump is used to remove the gas in the accommodation space S through the through holes 132, such that the pressure within the accommodation space S is lower than the ambient pressure, thereby forming a low pressure environment.

The thin film pressing module 140 is connected to the case 130 and is located in the accommodation space S. The thin film pressing module 140 receives the output thin films (for example, the thin film 200 and the metal thin film 210), and then stacks and presses the thin films (for example, the thin film 200 and the metal thin film 210) together in the low pressure environment, so as to form a laminated film 500. In this embodiment, the thin film pressing module 140 is formed by an upper pressing wheel 142 and a lower pressing wheel 144, the thin films (for example, the thin film 200 and the metal thin film 210) are conveyed to a position between the upper pressing wheel 142 and the lower pressing wheel 144, and are pressed by the upper pressing wheel 142 and the lower pressing wheel 144, so as to form a laminated film 500.

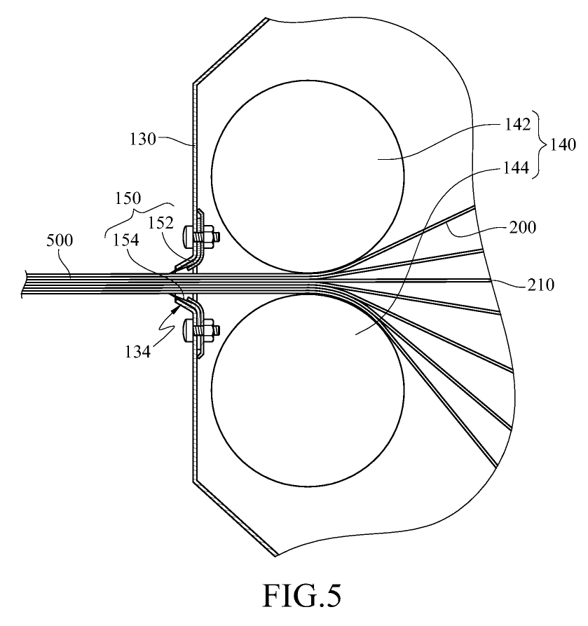

FIG. 5 is another schematic partially enlarged view of FIG. 2. Referring to FIGS. 2 and 5, the case 130 further comprises a laminated film outlet 134. The laminated film 500 output from the thin film pressing module 140 is sent out of the case 130 via the laminated film outlet 134. In addition, preferably, when the vacuum pump removes the gas in the accommodation space through the through holes 132, in order to prevent the gas from entering the case 130 from the exterior via the laminated film outlet 134, the device for producing the laminated film 100 of this embodiment further comprises an air-tight device 150, which is arranged on the laminated film outlet 134 and seals the laminated film outlet 134. In this embodiment, the air-tight device 150 comprises a pair of elastic sheets 152 and 154, which are respectively locked on two opposite sides of the laminated film outlet 134, and the laminated film 500 passes through the air-tight device 150 from a position between the pair of elastic sheets 152 and 154.

For the convenience of the pull-through operation of the operators, the case 130 of this embodiment further comprises an opening 136 and a cover plate 138 pivoted on one side of the opening 136. In this manner, the operators may perform the pull-through operation on the thin films (for example, the thin film 200 and the metal thin film 210) by opening the cover plate 138.

Based on the above descriptions, in the present invention, the thin films are pressed within the accommodating space, and the gas in the accommodation space is removed out of the case through the through holes in the case. Therefore, as compared with the conventional art, the present invention can reduce the probability that the gas is sandwiched between two adjacent thin films during the thin film pressing process, thereby improving the yield and service life of the products.

What is claimed is:

1. A device for producing a laminated film, adapted to be connected to a vacuum pump, comprising:
a first thin film extruding die, having a first conveying channel, and outputting a first thin film through the first conveying channel;
a second thin film extruding die, having a second conveying channel, and outputting a second thin film through the second conveying channel;
a case, forming an accommodation space together with the first thin film extruding die and the second thin film extruding die, wherein one end of the first conveying channel and one end of the second conveying channel are respectively communicated with the accommodation space, and the case comprises a through hole communicated with the accommodation space, and the case is connected to the vacuum pump through the through hole; and
a thin film pressing module, connected to the case and located in the accommodation space, wherein the thin film pressing module receives the output first thin film and the output second thin film, and presses the first thin film on the second thin film to form a laminated film.

2. The device for producing a laminated film according to claim 1, wherein one end of the first conveying channel communicated with the accommodation space is a flat opening.

3. The device for producing a laminated film according to claim 1, further comprising an air-tight device, wherein the case further comprises a laminated film outlet, the air-tight device seals the laminated film outlet, and the laminated film passes through the air-tight device and is output out of the device for producing a laminated film.

4. The device for producing a laminated film according to claim 3, wherein the air-tight device comprises a pair of elastic sheets, locked on two opposite sides of the laminated film outlet respectively, and the laminated film passes through the air-tight device from a position between the pair of elastic sheets.

5. The device for producing a laminated film according to claim 1, wherein a first thin film output module comprises a main body and a flow regulating module, the first conveying channel is located in the main body, and the flow regulating module is connected to the main body and is arranged on an extending path of the first conveying channel, so as to adjust a cross-sectional area of a part of segments of the second conveying channel.

6. The device for producing a laminated film according to claim 5, wherein the flow regulating module comprises a stopper and a driving module, the stopper is arranged on the extending path of the first conveying channel and is driven by the driving module to move relative to the first conveying channel, a moving direction of the stopper forms an angle with respect to an extending direction of the first conveying channel, and the angle is at a degree of a natural number.

7. The device for producing a laminated film according to claim 6, wherein the driving module comprises a fixed base, a worm gear set, and a worm, the fixed base is fixed on the main body, the worm gear set is pivoted on the fixed base in an eccentric manner and leans against the stopper, and the worm is inserted into the main body from an exterior of the main body and is connected to the worm gear set.

8. The device for producing a laminated film according to claim 5, wherein the first thin film output module further comprises a heating module, inserted into the main body and disposed adjacent to the first conveying channel.

9. The device for producing a laminated film according to claim 1, wherein a laminated film producing module is used to receive a third thin film, a gap exists between the first thin film extruding die and the second thin film extruding die, and a height of the gap is greater than a thickness of the third thin film, so that the third thin film enters the accommodation space through the gap.

10. The device for producing a laminated film according to claim 1, further comprising a heat insulating layer arranged between the first thin film extruding die and the second thin film extruding die.

11. The device for producing a laminated film according to claim 1, wherein the case further comprises an opening and a cover plate pivoted on one side of the opening.

12. The device for producing a laminated film according to claim 1, further comprising a temperature sensor, embedded in the first thin film extruding die, and disposed adjacent to the first conveying channel.
